(19) United States
(12) Patent Application Publication
(10) Pub. No.: US 2008/0143593 A1
(43) Pub. Date: Jun. 19, 2008

(54) SYSTEM AND METHOD FOR PROVIDING ASSET MANAGEMENT AND TRACKING CAPABILITIES

(75) Inventors: Robert August Graziano, Niskayuna, NY (US); Patricia Denise Mackenzie, Clifton Park, NY (US); Andrew John Calver, Westwood, CA (US); Kevin Chean, New York, NY (US); John William Carbone, Ballston Spa, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC, Schenectady, NY (US)

(21) Appl. No.: 11/610,891

(22) Filed: Dec. 14, 2006

(51) Int. Cl. H04B 7/185

(52) U.S. Cl. 342/357.09

(57) ABSTRACT

A system for providing asset management and tracking capabilities of a tractor-trailer system includes a trailer device coupled to a trailer. A tractor device is coupled to a tractor and configured to communicate with the trailer device using a first communication protocol. A hand held device is configured to communicate with the trailer device using a second communication protocol and with the tractor device using a third communication protocol. A remote monitoring center is configured to communicate with the trailer device, the tractor device, the hand held device, using a fourth communication protocol; wherein the remote monitoring center is configured to monitor the tractor-trailer system based on association between the trailer device, the tractor device, and the hand held device.

### BACKGROUND

The invention relates generally to a system and method for providing asset management and tracking capabilities. More particularly, the present invention relates to a system and method for providing asset management and tracking capabilities for a tractor-trailer system.

Maintaining an accurate and current record of assets has long been an area of focus for businesses that ship a large number of products or materials to a variety of customer locations. The tracking and location of assets such as rail cars, shipping or cargo containers, and the like can facilitate their being efficiently allocated and positioned, and can provide for immediate, accurate localization of lost, delayed or damaged assets. Conventionally, maintaining and tracking assets involved following a paper trail related to the assets. Unfortunately, much of the paperwork required to maintain the accuracy of the record is often either missing, late, or erroneously completed.

Another technique for enhancing the ability of shippers to maintain accurate records involves placement of unique computer-readable identification codes, e.g. bar codes on the assets. By scanning these at various waypoints during delivery, a record of the shipment process may be maintained. Unfortunately, this process requires the affirmative step of locating and scanning each identification code in a timely manner.

Accordingly, there is a need for a system and a method for providing asset management and tracking capabilities for a tractor-trailer system and that can provide a unified computing/decisioning platform that can exchange information and track overall operations of a tractor-trailer system.

### BRIEF DESCRIPTION

In accordance with one exemplary embodiment of the present invention, a system for providing asset management and tracking capabilities of a tractor-trailer system includes a trailer device coupled to a trailer. A tractor device is coupled to a tractor and configured to communicate with the trailer device using a first communication protocol. A hand held device is configured to communicate with the trailer device using a second communication protocol and with the tractor device using a third communication protocol. A remote monitoring center is configured to communicate with the trailer device, the tractor device, and the hand held device, using a fourth communication protocol; wherein the remote monitoring center is configured to monitor the tractor-trailer system based on association between the trailer device, the tractor device, and the hand held device.

In accordance with another exemplary embodiment of the present invention, a method for managing assets and tracking capabilities of a tractor-trailer system is provided. The method includes creating a first association between a hand held device and a tractor device by establishing communication between the hand held device and the tractor device. A second association is created between a trailer device and the tractor device by establishing communication between the trailer device and the tractor device. A super-entity representative of a combination of the hand held device, tractor device, and the trailer device configured to communicate with a remote monitoring center is established. The tractor-trailer system is monitored via a remote monitoring center based on association between the combination of the trailer device, the tractor device, the hand held device, with the remote monitoring center.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of a system for providing asset management and tracking capabilities of a tractor-trailer system in accordance with certain exemplary embodiments of the present invention;

FIG. 2 is a detailed diagrammatical representation of a system for providing asset management and tracking capabilities of a tractor-trailer system in accordance with an exemplary embodiment of the present invention; and

FIG. 3 is a flow chart illustrating exemplary steps involved in a method for providing asset management and tracking capabilities of a tractor-trailer system in accordance with certain exemplary embodiments of the present invention.

### DETAILED DESCRIPTION

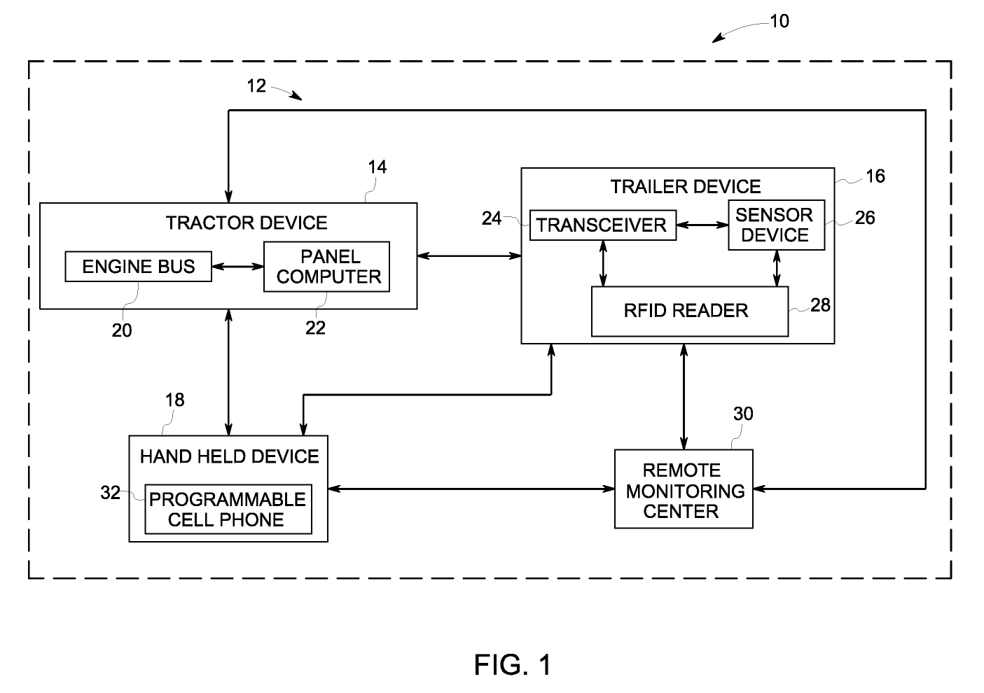

As discussed in detail below, embodiments of the present invention provide a system for providing asset management and tracking capabilities of a tractor-trailer system. The system includes a trailer device coupled to a trailer. A tractor device is coupled to a tractor and configured to communicate with the trailer device. A hand held device is configured to communicate with the tractor device and the trailer device. Association between the tractor device, trailer device, and the hand held device is established using wireless networking communication protocols. A remote monitoring center is configured to monitor the tractor-trailer system based on communication between the trailer device, the tractor device, and the hand held device. In accordance with certain other embodiments of the present invention, a method for managing assets and tracking capabilities of a tractor-trailer system is provided. The method includes establishing a super-entity representative of a combination of the hand held device, tractor device, and the trailer device configured to communicate with a remote monitoring center. It should be noted herein that the super-entity is established by ad-hoc association between the tractor device, trailer device, and the hand held device. The super-entity is established for the purpose of communicating to a remote monitoring center or a back-office. The data associated with the tractor device, trailer device, and the hand held device is tracked and processed via the remote monitoring center to perform various analysis related to the tractor-trailer system. The analysis is facilitated based on data associated with tractor/trailer, tractor/hand held device, trailer/ hand held combinations or so forth. Specific embodiments of the present invention are discussed below referring generally to FIGS. 1-3.

Referring to FIG. 1, a tractor-trailer system 10 provided with a system 12 for asset management and tracking capabilities is illustrated in accordance with an exemplary embodiment of the present invention. The system 12 includes a tractor device 14, a trailer device 16, and a hand held device 18. It should be noted that the “tractor device” 14 refers to a device provided to a tractor, and the “trailer device” 16 refers to a device provided to a trailer. The hand held device 18 refers to a communication device (for example, personal digital assistant (PDA) or a programmable cell phone) provided to a driver of the tractor-trailer system 10. In addition to tractor-trailers, the systems and techniques described herein may be applied to other systems, such as cargo ships and the like. The tractor device 14 is configured to communicate with the trailer device 16 using a first communication protocol (e.g. Zigbee communication protocol). The trailer device 16 is configured to communicate with the hand held device 18 using a second communication protocol (e.g. WiFi communication protocol). The tractor device 14 is configured to communicate with the hand held device 18 using a third communication protocol (e.g. Bluetooth). It should be noted that in certain embodiments, that first, second, and third communication protocols may include the same communication protocol.

In the illustrated embodiment, the tractor device 14 includes an engine bus 20 and a panel computer 22. The trailer device 16 includes a transceiver 24, a sensor device 26, and an electronic asset identification device such as a RFID reader 28. The transceiver 24 is configured to wirelessly communicate (i.e. receive and transmit wireless signals) with the sensor device 26, the panel computer 22, RFID reader 28, the hand held device 18, and a remote monitoring center 30. One example of such a transceiver 24 is a VeriWise™ hub, produced by the General Electric Company. The sensor device 26 may include a plurality of sensors provided to the trailer. The hand held device 18 includes a programmable cell phone 32. The remote monitoring center 30 is configured to monitor the tractor-trailer system based on communication between the trailer device, the tractor device, and the hand held device.

The RFID reader 28 reads or scans RFID tags affixed at the point of shipment to each asset (for example, crate, storage or packing containers, cargo, or the like) that is to be tracked. An electronic association is made between RFID tag and the material being shipped and may be transmitted in an automated fashion to the remote monitoring center 30 via the hand held device 18 or the transceiver 24. As the material is transported from the location of shipment to the destination, updates along the travel route may be recorded automatically and remotely through interrogation of the RFID readers. The information is shared with a client computer system (not shown) and updates on status or deposition of material may then be transmitted in a wireless mode to the remote monitoring center 30. It should be noted herein that the architecture of the system 12 is an exemplary embodiment and may vary depending on the requirement. Details of the system and communication protocols between the components of the system 12 are explained in greater detail below.

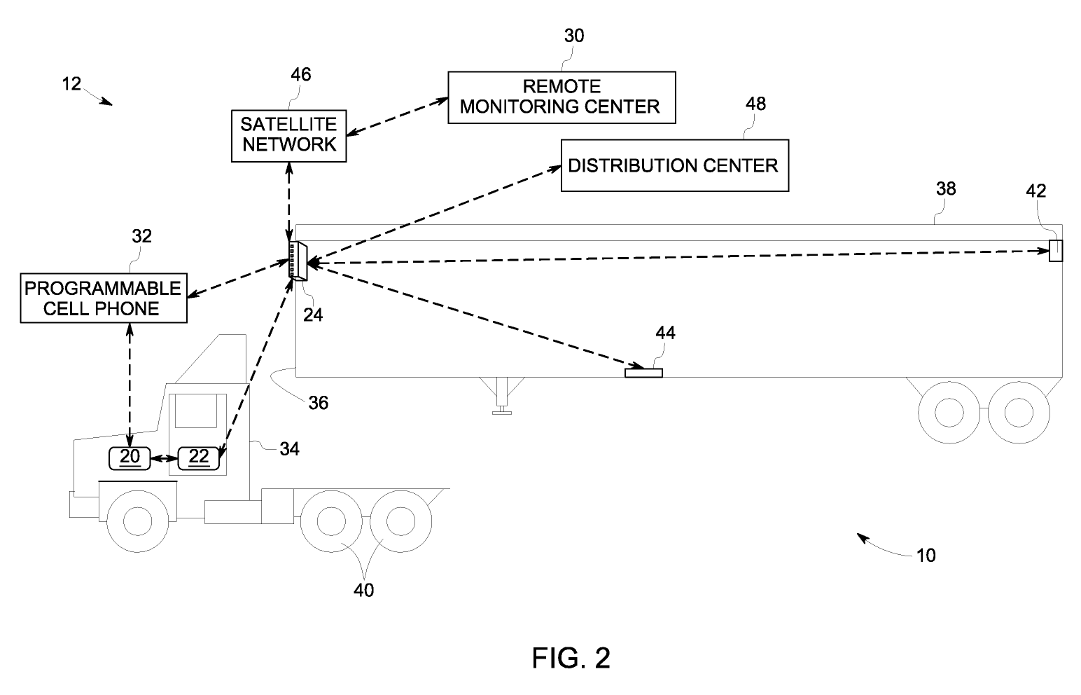

Referring to FIG. 2, the system 12 for providing asset management and tracking capabilities of the tractor-trailer system 10 is illustrated in accordance with an exemplary embodiment of the present invention. In operation, the coupled to a front end 36 of system 12 is used to globally track and manage a mobile asset whose location and information are especially important. In the illustrated embodiment, the tractor-trailer system 10 includes a cab (tractor) 34 and trailer 38. The cab 34 and the trailer 38 are supported by a plurality of tires 40. The trailer 38 is configured to typically transport cargo or goods.

The tractor device includes the engine bus 20 and the panel computer 22 provided to the cab 34. The trailer device 16 includes the transceiver 24 and the sensor device provided to the trailer 38. The transceiver 24 includes a two-way data transmission system in which various type of information may be sent from and received by the transceiver 24. Messages about activity at the trailer 38 such as door position and cargo status, the entering or exiting of geofences, or the like are transmitted from the transceiver 24 provided on the trailer 38. It should be noted that a “geofence” may be referred to as a geographical region that is predefined and use to trigger an event when a user enters the region. The purpose of a geofence is to create a custom, electronic fence around a set of moving resources (e.g., delivery vehicles, construction equipment, patrol officers, etc.) that can be used to signal an alert when a resource has crossed a boundary. Modifications to geofences, requests for location, turning on or off of the sensor device, or the like are transmitted to the transceiver 24 using over-the-air (OTA) commands.

The sensor device includes a plurality of sensors such as a door sensor 42, a tire pressure sensor 44, among others. The door sensor 42 indicates whether the door is in open position or closed position. The tire pressure sensor 44 indicates pressure of the tires 40. Although only two sensors 42, 44 are provided, in certain other exemplary embodiments, a plurality of other sensors such as temperature sensor, humidity sensor, cargo sensor may also be provided to the trailer 38.

In the illustrated embodiment, the engine bus 20 is configured to communicate with the panel computer 34 using communication protocols such as Zigbee communication protocol. It should be noted that in certain exemplary embodiments, the panel computer is configured to print a plurality of reports, or direction maps, a combination thereof. The transceiver 24 is configured to communicate with the panel computer 22 using wired connection or wireless connection, such as, but not limited to WiFi, or Bluetooth, or Zigbee, or a combination thereof. The transceiver 24 is configured to communicate with the sensors 42, 44 using Zigbee communication protocols. The system 12 includes the programmable cell phone 32 provided to a driver configured to communicate with the engine bus 20 and the transceiver 24 using Bluetooth, or WiFi, or a combination thereof. In certain exemplary embodiments, the programmable cell phone 32 may be used to scan cargo tagged with RFID status loaded in the trailer so as to monitor the storage condition provided in the trailer 38. In certain other exemplary embodiments, the programmable cell phone 32 is configured to communicate with the remote monitoring center 30 using cell communication protocols. The remote monitoring center 30 is configured to monitor the tractor-trailer system based on communication with the trailer device 16, the tractor device 14, and the hand held device 18.

In the illustrated embodiment, the transceiver 24 is configured to communicate with one or more remote monitoring centers 30 using satellite network 46 i.e. global communication protocols. The transceiver 24 is also configured to communicate with a distribution center 48 (for example, a depot in which trailer has parked) using communication protocols such as WiFi.

As discussed previously, a super-entity is established by ad-hoc association between the tractor device, trailer device, and the hand held device. The super-entity is established for the purpose of communicating to the remote monitoring center 30 or a back-office. In one exemplary embodiment, the combination of programmable cell phone 32 and transceiver 24 with the panel computer 22 may form a super-entity. In another exemplary embodiment, the combination of programmable cell phone 32 and engine bus 20 with transceiver 24 may form another super-entity. Similarly, any number of combinations to form a super-entity is envisaged. The data associated with the tractor device, trailer device, and the hand held device is tracked and processed via the remote monitoring center to perform various analysis related to the tractor-trailer system. The remote monitoring center 30 is configured to identify the components that are coupled together into an ad-hoc super-entity and to use the association between components of the super-entity to perform a complete analysis.

Various kinds of information may be needed to be transmitted to a driver or a cab from the trailer 38. Some non-limiting examples of such information may include inventory related data such as real time temperature of the inventory and the physical loads that the inventory is subject to during transport. In another example, the information may be related to condition of the trailer such as tire pressure and condition of bearings. Remote monitoring center 30 and distribution center 48 that track trailers may also generally need to communicate information to drivers of such vehicles. Some non-limiting examples of the information may include location based information such as traffic alerts, locations of nearby restaurants, and weather related information. Some non-limiting examples of the vehicles may include trailer trucks and cargo ships.

In certain embodiments, to obtain an accurate location of the tractor-trailer system, the transceiver collects signals from multiple global positioning satellites. The location is calculated by the transceiver 24 and transmitted through the satellite network 46 to the remote monitoring center 30. In certain exemplary embodiments, the transceiver 24 generates a message “geofence entered” or geofence exited” along with location date and time. The message may then be transmitted through the satellite network 46 to the remote monitoring center 30. Users may create, modify, assign and delete geofences using appropriate communication protocols from the remote monitoring center 30 to the transceiver 24 provided on the trailer 24. Alerts may be set to notify key people of geofence entered/exited activity.

In certain exemplary embodiments, the transceiver 24 generates a message “door opened” or “door closed” along with location, date, and time. The message is transmitted through the satellite network 46 to the remote monitoring center 30. Users may turn on or off door sensors using web interfaces by transmitting commands using communication protocols from the remote monitoring center 30 to the transceiver 24 provided on the trailer 38. Alerts can be set to notify whether doors are opened or closed. In certain other exemplary embodiments, the transceiver 24 generates a message “cargo loaded” or “cargo empty” along with location, date, and time. The message is transmitted through the satellite network 46 to the remote monitoring center 30. Users may turn on or off cargo sensors using web interfaces by transmitting commands using communication protocols from the remote monitoring center 30 to the transceiver 24 provided on the trailer 38. Alerts can be set to notify cargo status.

In accordance with the illustrated embodiment, the remote monitoring center 30 identifies components that are connected together into a ad-hoc super-entity and is configured to monitor a plurality of parameters such as fuel usage, tire usage, engine usage, brake usage, transmission system usage, based on communication between the trailer device, tractor device, and the hand-held device. For instance, if the system were to detect that when pulling heavy trailers, that a particular driver was notably less efficient, or that brake wear/tire wear for the particular wear is more than other drivers in similar circumstances, the analysis information may be acted upon to improve efficiency/reduced wear. Similarly any number of parameters related to the tractor-trailer system may be analyzed.

In certain exemplary embodiments, when a message needs to be communicated to a driver of the tractor-trailer system, the remote monitoring center 30 sends a wireless signal to the trailer 38. The signal is transmitted to the transceiver 24 located in the trailer 38. The transceiver 24 further transmits a signal to the panel computer 22 provided in the tractor. The signal is relayed to the driver in the tractor via various modes. In an example, the signal may be an alert relayed as a text message. In another example, the signal may be an alert relayed as a voice message. In a particular embodiment, the driver may hear a voice message over a programmable cell phone 32, or FM radio station. In another embodiment, the signal may be transmitted over a XM radio signal. In yet another embodiment, the signal may be a low power radio signal. In another example, the signal may be transmitted as a WiFi signal. In a specific embodiment, the signal may be transmitted from a RFID tag corresponding to a specific trailer.

The remote monitoring center 30 may communicate various types of information to the driver through the transceiver 24. In a particular embodiment, the remote monitoring center 30 may send a weather alert signal to the transceiver 24 that is to be communicated to the driver. In another embodiment, the remote monitoring center 30 may send an alert signal regarding traffic delays on relevant routes to the transceiver 24 that forwards the same to the driver. In another embodiment, a message may be transmitted directly from the trailer 38 to the tractor device.

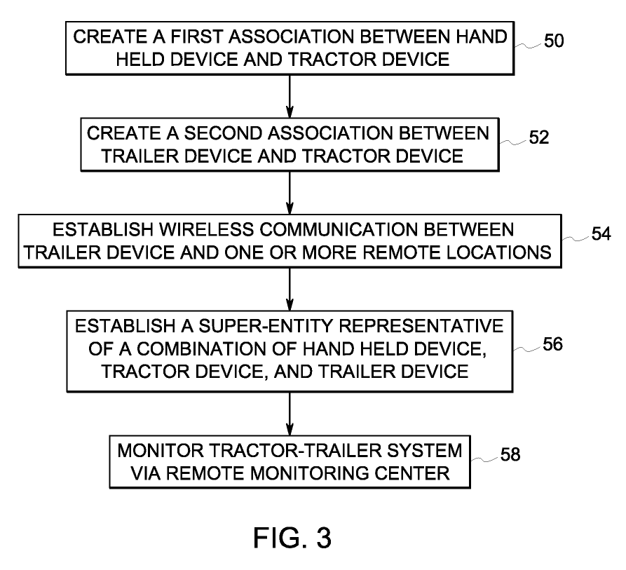

Referring to FIG. 3, exemplary steps involved in a method for providing asset management and tracking capabilities of a tractor-trailer system is illustrated in accordance with certain exemplary embodiments of the present invention. The method includes creating a first association between a hand held device and a tractor device by establishing communication between the hand held device and a tractor device as represented by the step 50. The hand held device 18 may include a programmable cell phone. As discussed previously, the tractor device includes the engine bus, and the panel computer. The tractor device is configured to communicate with the hand held device using communication protocols such as Bluetooth. The programmable cell phone provided to a driver communicates with the engine bus and the transceiver using Bluetooth, or WiFi, or a combination thereof.

The method also includes creating a second association between a trailer device and the tractor device as represented by the step 52. The trailer device includes a transceiver, a sensor device, and an electronic asset identification device such as a RFID reader. The transceiver wirelessly communicates (i.e. receive and transmit wireless signals) with the sensor device, the panel computer, RFID reader, the hand held device, and a remote monitoring center.

Messages about activity at the trailer such as door position and cargo status, the entering or exiting of geofences, or the like are transmitted from the transceiver provided on the trailer. The transceiver communicates with the panel computer using a wired connection, or WiFi, or Bluetooth, or Zigbee, or a combination thereof. The transceiver also communicates with the sensors using Zigbee communication protocols. The method further includes establishing wireless communication between the trailer device and one or more remote locations using satellite communication protocols as represented by the step 54. In the illustrated embodiment, the transceiver communicates with one or more remote monitoring centers using a satellite network i.e. global communication protocols. The transceiver may also communicate with a distribution center using communication protocols such as WiFi. In certain exemplary embodiments, when a message needs to be communicated to a driver of the tractor-trailer system, the remote monitoring center sends a wireless signal to the trailer. The signal is transmitted to the transceiver located in the trailer. The transceiver further transmits a signal to the panel computer provided in the tractor. The remote monitoring center 30 may communicate various types of information to the driver through the transceiver 24.

The method further includes establishing a super-entity representative of a combination of the hand held device, tractor device, and the trailer device configured to communicate with the remote monitoring center as represented by the step 56. The super-entity is established by ad-hoc association between the tractor device, trailer device, and the hand held device. The super-entity is established for communicating to the remote monitoring center or a back-office. The data associated with the tractor device, trailer device, and the hand held device is tracked and processed via the remote monitoring center to perform various analysis related to the tractor-trailer system. The analysis is facilitated based on data associated with tractor/trailer, tractor/hand held device, trailer/ hand held device combinations or so forth. The components that are coupled together into an ad-hoc super-entity are identified and the association between components of the super-entity are used perform a complete analysis. The method further includes monitoring the tractor-trailer system via the remote monitoring center based on communication between the combination of the trailer device, the tractor device, the hand held device, and the remote monitoring center as represented by the step 58. The analysis is facilitated based on data associated with tractor/trailer, tractor/hand held device, trailer/hand held device combinations or so forth

Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. The various features described, as well as other known equivalents for each feature, can be mixed and matched by one of ordinary skill in this art to construct additional systems and techniques in accordance with principles of this disclosure.

Although the systems herein have been disclosed in the context of certain preferred embodiments and examples, it will be understood by those skilled in the art that the invention extends beyond the specifically disclosed embodiments to other alternative embodiments and/or uses of the systems and techniques herein and obvious modifications and equivalents thereof. Thus, it is intended that the scope of the invention disclosed should not be limited by the particular disclosed embodiments described above, but should be determined only by a fair reading of the claims that follow.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system for providing asset management and tracking capabilities of a tractor-trailer system, comprising:
a trailer device coupled to a trailer;
a tractor device coupled to a tractor and configured to communicate with the trailer device using a first communication protocol;
a hand held device configured to communicate with the trailer device using a second communication protocol and with the tractor device using a third communication protocol; and
a remote monitoring center configured to communicate with the trailer device, the tractor device, and the hand held device, using a fourth communication protocol; wherein the remote monitoring center is configured to monitor the tractor-trailer system based on the association between the trailer device, the tractor device, and the hand held device.

2. The system of claim 1, wherein the trailer device comprises a transceiver configured to communicate with the tractor device using the first communication protocol, wherein the first communication protocol comprises a wired connection, or WiFi, or Bluetooth, or Zigbee.

3. The system of claim 2, wherein the transceiver is configured to communicate with the remote monitoring center using WiFi communication protocol.

4. The system of claim 3, wherein the transceiver is configured to communicate with one or more remote locations using a satellite communication protocol.

5. The system of claim 3, wherein the transceiver is configured to communicate with a door sensor provided to the trailer using Zigbee communication protocol.

6. The system of claim 3, wherein the transceiver is configured to communicate with a tire pressure sensor provided to the trailer using Zigbee communication protocol.

7. The system of claim 3, wherein the tractor device comprises a panel computer; wherein the transceiver is configured to communicate with the panel computer using a wired connection, or WiFi, or Bluetooth, or Zigbee.

8. The system of claim 7, wherein the panel computer is configured to communicate with an engine bus provided to the tractor using Zigbee communication protocol.

9. The system of claim 8, wherein the panel computer is configured to print a plurality of reports, or direction maps.

10. The system of claim 7, wherein the hand held device is configured to communicate with the engine bus using the third communication protocol and wherein the third communication protocol comprises Bluetooth, or WiFi.

11. The system of claim 3, wherein the hand held device is configured to communicate with the transceiver using the second communication protocol; wherein the second communication protocol comprises Bluetooth, or WiFi.

12. The system of claim 1, wherein the hand held device is configured to scan cargo tagged with radio frequency identification status provided in the trailer, wherein the hand held device may be used to monitor storage condition of the cargo provided in the trailer.

13. The system of claim 1, wherein the hand held device is configured to communicate with the remote monitoring center using the fourth communication protocol, wherein the fourth communication protocol comprises a cell communication protocol.

14. The system of claim 1, wherein the remote monitoring center is configured to monitor fuel usage of the tractor-trailer system based on the association between the trailer device, the tractor device, and the hand held device.

15. The system of claim 1, wherein the remote monitoring center is configured to monitor tire usage of the tractor-trailer system based on the association between the trailer device, the tractor device, and the hand held device.

16. The system of claim 1, wherein the remote monitoring center is configured to monitor engine usage of the tractor-trailer system based on the association between the trailer device, the tractor device, and the hand held device.

17. The system of claim 1, wherein the remote monitoring center is configured to monitor brake usage of the tractor-trailer system based on the association between the trailer device, the tractor device, and the hand held device.

18. The system of claim 1, wherein the remote monitoring center is configured to monitor transmission system usage of the tractor-trailer system based on the association between the trailer device, the tractor device, and the hand held device.

19. A method for managing assets and tracking capabilities of a tractor-trailer system, comprising:
creating a first association between a hand held device and a tractor device by establishing communication between the hand held device and the tractor device;
creating a second association between a trailer device and the tractor device by establishing communication between the trailer device and the tractor device; and
establishing a super-entity representative of a combination of the hand held device, tractor device, and the trailer device configured to communicate with a remote monitoring center;
monitoring the tractor-trailer system via a remote monitoring center based on association between the combination of the trailer device, the tractor device, the hand held device of the super-entity, and the remote monitoring center.

20. The method of claim 19, wherein creating the second association between the trailer device and the tractor device comprises establishing communication between tractor device and the trailer device using a first communication protocol.

21. The method of claim 20, comprising establishing communication between tractor device and the trailer device using a wired connection, or WiFi, or Bluetooth, or Zigbee.

22. The method of claim 20, further comprising establishing wireless communication between the trailer device and the remote monitoring center using WiFi communication protocol.

23. The method of claim 22, further comprising establishing wireless communication between the trailer device and one or more remote locations using satellite communication protocols.

24. The method of claim 19, wherein creating the first association between the hand held device and the tractor device comprises establishing wireless communication between the hand held device with an engine bus provided to a tractor using a third communication protocol.

25. The method of claim 24, comprising establishing wireless communication between the hand held device with the engine bus provided to the tractor using Bluetooth, or WiFi.

26. The method of claim 19, further comprising establishing wireless communication between the hand held device and the trailer device using a second communication protocol.

27. The method of claim 26, comprising establishing wireless communication between the hand held device and the trailer device using Bluetooth, or WiFi.

28. The method of claim 19, further comprising scanning cargo tagged with radio frequency identification status provided in a trailer, using the hand held device to monitor storage condition of a cargo in the trailer.

29. The method of claim 19, further comprising establishing wireless communication between the hand held device and the remote monitoring center using a fourth communication protocol.

30. The method of claim 29, comprising establishing wireless communication between the hand held device and the remote monitoring center using a cell communication protocol.

31. The method of claim 19, comprising monitoring tire usage of the tractor-trailer system via the remote monitoring center based on association between the trailer device, the tractor device, and the hand held device.

32. The method of claim 19, comprising monitoring engine usage of the tractor-trailer system via the remote monitoring center based on association between the trailer device, the tractor device, and the hand held device.

33. The method of claim 19, comprising monitoring brake usage of the tractor-trailer system via the remote monitoring center based on association between the trailer device, the tractor device, and the hand held device.

34. The method of claim 19, comprising monitoring transmission system usage of the tractor-trailer system via the remote monitoring center based on assocation between the trailer device, the tractor device, and the hand held device.
